(19) United States
(12) Patent Application Publication
(10) Pub. No.: US 2026/0171778 A1
(43) Pub. Date: Jun. 18, 2026

(54) Modular Precast Foam Duct Bank

(71) Applicant: Taylor Moson, San Diego, CA (US)

(72) Inventor: Taylor Moson, San Diego, CA (US)

(21) Appl. No.: 19/357,929

(22) Filed: Oct. 14, 2025

Related U.S. Application Data
(60) Provisional application No. 63/706,190, filed on Oct. 11, 2024.

(51) Int. Cl. H02G 9/06

(52) U.S. Cl. CPC H02G 9/065

(57) ABSTRACT

The present invention discloses a modular precast foam duct bank that is manufactured entirely out of expanded polystyrene (EPS). The modular precast foam duct banks are used for the installation of underground utilities that require the use of utility conduits to protect the utility wires. The use of EPS for a modular precast foam duct bank eliminates the need to use concrete to install utility connections, which will make the process much more efficient. EPS is lightweight, durable, and has high compressive strength. As such, the costs and time required to install utilities will drop drastically for projects that use the present invention. Additionally, a single run of the modular precast duct bank can be made up of straight runs, or turns that very from 90, 60, 45, and 30 degrees.

### RELATED APPLICATIONS

This application claims priority to U.S. Provisional Application No. 63/706,190, for “Modular Precast Foam Duct Bank” filed on Oct. 11, 2024, and currently co-pending, the entirety of which is incorporated herein by reference.

### FIELD OF THE INVENTION

The present invention pertains generally to a duct bank constructed out of expanded polystyrene that greatly improves the installation process of underground utility connections for buildings; providing a system that is modular, low cost, and easy to install.

### BACKGROUND OF THE INVENTION

The use of duct banks for the installation of utility lines has become commonplace during the construction process for new builds or the renovation of existing structures. Duct banks themselves are currently made up of utility conduits that are encased in concrete. The current process is one that is tedious and demanding due to the work that is involved, because the utility conduits that are used need to be encased in concrete prior to pulling any utility lines.

The existing process can generally be described as involving the following steps. First, a trench is dug and shored up in accordance with the needs of the specific construction project. Second, the individual utility conduits are laid into the trench and installed with spacers to minimize contact between the individual conduits. Third, rebar is then installed, and once that step is complete, the concrete is poured into the trench and allowed to cure before backfilling the trench to bring it to grade.

Not only is the current process time consuming and expensive, it can also become unnecessarily complicated. For example, if it rains at the construction site prior to the pouring of concrete, the trench will need to be drained before any concrete can be poured. Yet another example that points out the current inefficiency of the installation process is that pouring of concrete is dependent on the ambient conditions in order to set properly. If the weather surrounding the construction site is not acceptable, then construction crews are forced to wait until the weather improves to pour the concrete; resulting in significant delays to the entire project.

There are some current solutions that are available to construction crews, but these systems do not solve the entire problem. One solution that is available is to order precast duct banks that have the utility conduits already encased in concrete. While this system does save a significant amount of installation time, they are still priced too high, and does not meaningfully lower the labor or transportation costs associated with installation of utilities, nor does it do enough the streamline the process as a whole.

Therefore, there is a need for a new type of duct bank that continues to improve the timeline and efficiency for the installation process while simultaneously lowering the costs associated with such a project.

### SUMMARY OF THE INVENTION

The present invention is a modular precast duct bank system that is made out of expanded polystyrene (EPS). EPS is an ideal material to use for precast duct banks due to its favorable material characteristics. Not only does EPS have a high compressive strength rating, but it is also lightweight and has exceptional dimensional stability. Other features that make EPS an ideal choice for duct banks is that EPS is also resistant to mold, bacteria, mildew, and water runoff that is common in day-to-day life. As such, duct banks that are made out of EPS are durable, long lasting, and high-quality units that can be installed in almost any scenario.

The material choice of EPS will also make the process of utility installation much more efficient. Each unit will be lightweight and easily maneuverable without the use of heavy machinery. This will eliminate the need for construction crews to use heavy machinery, like cranes, to position each individual component and minimizes the risk of damage to the duct bank during the installation process. Once the entire system is installed, construction crews will only have to backfill the trench to grade according to local building codes in order to complete the project.

There are a number of environmental benefits that will come with the use of the present invention. Fuel costs associated with the transportation and installation of utility lines will be reduced dramatically due to EPS being significantly lighter than concrete. Additionally, EPS is recyclable at multiple different points through its use cycle. Therefore, if a building is demolished or the number of utility connections needed is reduced, then the existing EPS systems can be dug up and reused at a different project. Finally, EPS is inert and non-toxic, so there is little concern for toxic waste leaching into the surrounding soil.

The modular precast foam duct bank disclosed here can be made up of a number of different types of foam pieces. For example, a single system can have straight foam pieces, 90-degree turn pieces, and even 60-degree pieces. Further, the modularity of each piece allows for either vertical or horizontal turns, allowing the entire system to undergo elevation changes within a trench, should such a change be required.

These and other objects, features, and advantages of the present disclosure will become apparent upon reading the following detailed description of exemplary embodiments of the present disclosure, when taken in conjunction with the appended drawings, and provided paragraphs.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front view of the top or bottom panel of the fully assembled modular precast foam duct bank;

FIG. 2 is a front view of the intermediate panel that will be layered in between the top and bottom panels of the fully assembled modular precast foam duct bank;

FIG. 3 is a front view of the fully assembled modular precast foam duct bank;

FIG. 4 is a section view of the fully assembled modular precast foam duck bank installed in a trench;

FIG. 5 is a top view of the fully assembled modular precast foam duct bank with utility conduits running through the interior;

FIG. 6 is a top view of a 90 degree turn for the modular precast foam duct bank;

FIG. 7 is a top view of a 60 degree turn for the modular precast foam duct bank;

FIG. 8 is a top view of a fully assembled modular precast foam duct bank that has a straight, 90-degree turn, and a 60-degree turn;

FIG. 9 is a side view of a fully assembled modular precast foam duct bank that is routed into a data center; and

FIG. 10 is a perspective view of the fully assembled precast duct bank with utility conduits installed and strapped together with bands.

### DETAILED DESCRIPTION

Expanded polystyrene (EPS) is a rigid, closed cell, thermoplastic foam that is produced from individual solid beads of polystyrene that have an expansion gas placed within each individual bead. The manufacturing process of EPS involves the heating of the individual beads so that the expansion gas dissolves within each bead and subsequently evaporates; forcing the beads to expand considerably in size. The beads are joined together and shaped in accordance with the specific mold used for a given product. When the manufacturing process is complete, the resulting product made from a versatile and durable material is left behind.

The manufacturing process of EPS is relatively straightforward and can be generally described through the following steps. First, in a preferred embodiment of the present invention, the individual beads are placed into a pre-expander machine and heated until the expansion gas evaporates. The evaporation of the expansion gas causes each individual bead to drastically increase in size and fuse with other beads in the machine. In the second step, the now expanded beads are left to cool and age for a period of time to ensure that the expanded beads are stable enough for the molding process. Once the proper amount of time has passed, the expanded beads are placed within a preselected mold and subsequently heated for a second time until the beads are fully expanded and take the shape of the mold itself. The molded beads are then cooled with either water or air to ensure that the now molded EPS does not deform. Any final cuts that need to be made to ensure that the molded EPS has the proper shape can occur once the cooling process is completed.

There are a number of unique properties of EPS that are relevant for use in the shaping of the precast foam duct bank of the present invention. The first is the high compressive strength of EPS in relation to its low weight. Additionally, it has exceptional dimensional stability that allows each individual modular precast foam duct bank 100 to remain unaffected by temperature fluctuations and other ambient conditions that each unit will be exposed to while installed underground. The high compressive strength and outstanding dimensional stability of each modular precast foam duct bank 100 is invaluable when the purpose of duct banks is taken into account.

Utility connections are a necessity in the modern construction process, and it has become commonplace to install the utility lines underground. The utility connections, namely electrical, cable, and internet wiring, need to be installed within utility conduit pipes to ensure each cable is not damaged when installed underground. Also, the conduit provides for the addition or removal of cables or wires post-installation as needed without having to replace or excavate the conduit. Often, these conduits are encased in concrete to provide the compressive strength that is required to protect utility conduits and the utility lines from damage. Further, by protecting the utility conduits the installation of new utility lines, such as fiber optic internet connection, or the repair of existing utility lines becomes much easier. The use of EPS in the construction of modular precast foam duct bank 100 replaces the need for concrete in most installations.

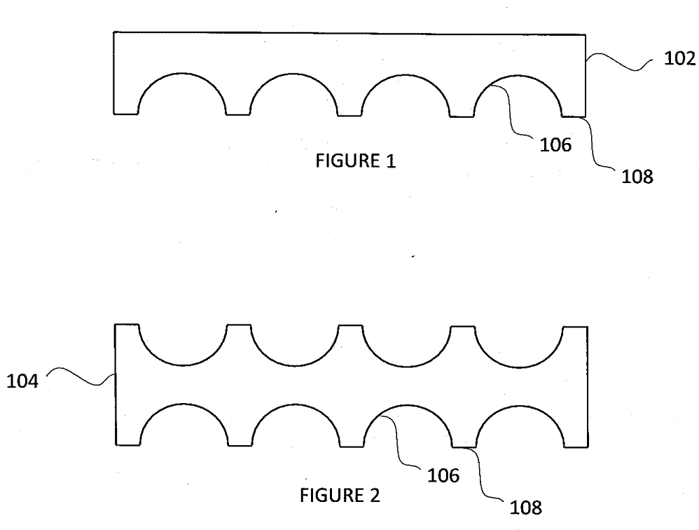

Referring initially to FIG. 1, a front view of surface foam 102 that will serve as both the top and bottom piece of modular precast foam duct bank 100. In this figure, conduit recess 106 was sized for 6″ PVC conduit, but that is not intended to be limiting. In fact, the entirety of modular precast foam duct bank 100 can be manufactured to accommodate a variety of different designs that includes different sized utility conduits and conduits that are made from different materials than PVC. Contact point 108 is what secures surface foam piece 102 to intermediary foam piece 104.

Referring now to FIG. 2, intermediary foam piece 104 is shown. Precast foam duct bank 100 can have any number of intermediary foam pieces 104 as needed for a specific job. Further, during the manufacturing process, intermediary foam piece 104 will be manufactured so that its dimensions (conduit recess 106 and contact point 108) correspond with the dimensions of surface foam piece 102, and any other intermediary foam pieces 104 that may be needed. Like surface foam piece 102, intermediary foam piece 104 is fully customizable to accommodate different sized utility conduits and specific conduit layouts. Additionally, conduits of different sizes, such as a 2″ and 6″, can be received within appropriately sized conduit recesses 106 in surface foam piece 102 and intermediary foam piece 104 to provide for a precast foam duct bank having differing conduit diameters. As a result, all of modular precast foam duct bank 100 can be customized to meet the needs of any job.

Additionally, while the four exemplary conduit recesses 106 are all the same diameter as shown in FIGS. 1 and 2, it is to be appreciated that surface foam 102 and intermediary foam 104 may be formed to accept conduit having different diameters, such as a 10 inch, a 6 inch, and multiple 3-inch conduits. Further, while the preferred embodiments disclosed herein depict a modular precast foam duct bank 100 having four conduit recesses 106, it is to be appreciated that this is merely exemplary and not intended to limit the number or size of conduit that can be accommodated within modular precast foam duct bank 100.

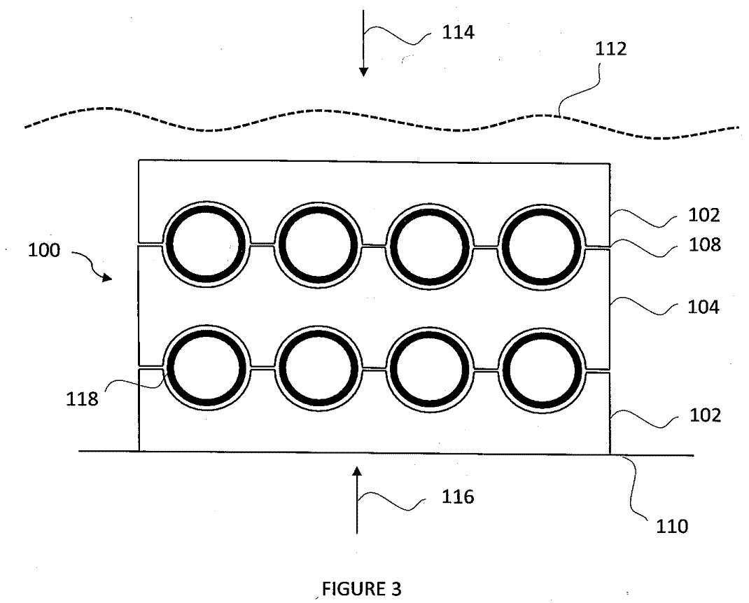

Referring now to FIG. 3, a front view of a fully assembled modular precast foam duct bank 100 is shown. In this embodiment intermediary foam piece 104 is sandwiched between two surface foam pieces 102. In this figure, the contact between the different contact points 108 are in contact with each other to secure the entire assembly. When modular precast foam duct bank 100 is fully assembled as shown here, the compressive strength of each individual foam piece, attributable to the material properties of EPS, prevents the entire assembly from failing.

The uniform design in conjunction with the lightweight properties of EPS makes it easy to both transport and install modular precast foam duct bank 100 at the job site. The end result of use of the system of the present invention is lower transportation, labor, and fuel cost. More individual units of surface foam pieces 102 and intermediary foam pieces 104 can be transported by one vehicle, and each piece is significantly lighter than concrete so fewer construction workers will be needed on site.

When modular precast foam duct bank 100 is installed, it will rest completely at trench bottom 110. Precast foam duct bank 100 will then subsequently be covered by backfill material 112. However, once backfill material 112 is compacted in accordance with industry standards, a compressive force 114 will be applied to modular precast foam duct bank 100. There will also be another compressive force 116 applied to modular precast foam duct bank 100 at trench bottom 110 to resist modular precast foam duct bank pushing into the ground. The compressive strength of EPS is high enough to protect the structural integrity of the entire modular precast foam duct bank 100. Additionally, each contact point 108 interacting with each other will ensure that each foam piece is properly seated and each utility conduit 118 will be protected.

To ensure a secure connection between the different contact points 108, a general EPS adhesive can be used. Any type of approved adhesive can be used, but some types, such as foam safe adhesive may be preferred. This is because foam safe adhesives are designed to ensure that the adhesive does not unintentionally deform or melt the EPS. However, any known EPS adhesive in the art is fully contemplated herein. Once the EPS adhesive is applied, a user just needs to allow for the curing process to occur before any backfill is used.

Each individual foam piece that makes up modular precast foam duct bank 100 will be lightweight and easy to work with. As such, the installation process of each modular precast foam duct bank 100 will be significantly more efficient than existing methods.

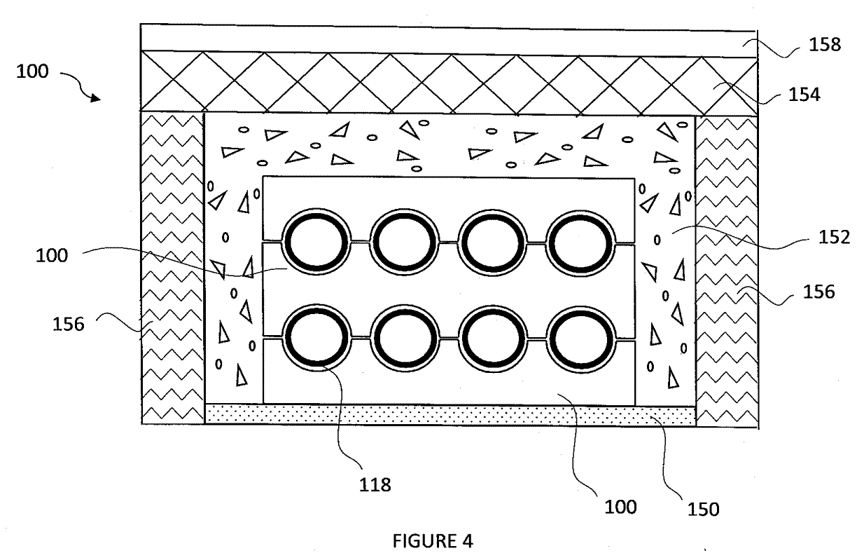

Referring now to FIG. 4, a section view of modular precast foam duct bank 100 installed within a trench is shown. The bottom of the trench has sand 150 leveled out so that the entire assembly of modular precast foam duct bank 100 can lay level on top. Trench walls 156 will be spaced apart from each other in accordance with the desired width of the trench, and be sized so that modular precast foam duct bank 100 can fit within the trench even if a layer of concrete 152 is laid down, which may be necessary depending on the local building codes of the area. If concrete 152 is required, then modular precast foam duct bank 100 will need to be encased in concrete 152 before the trench is brought back to grade with backfill 154. Once backfill 154 has satisfactorily filled the trench, then surface 158 can be laid on top of it. Surface 158 is merely descriptive and may take the shape of any surface known in the art such as landscaping or sidewalk.

Encasing modular precast foam duct bank 100 in this embodiment with concrete 152 provides additional protection for utility conduit 118. This is important when utility conduit 118 is being used to run high voltage lines to a building. Without additional protection, then it becomes much easier for an excavator to accidentally make contact with the high voltage line which could result in significant injury.

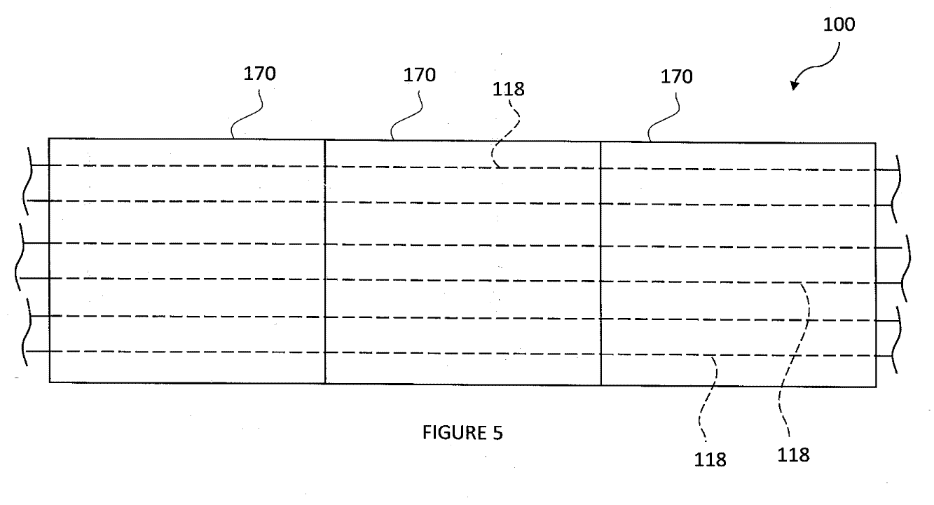

Referring now to FIG. 5, a top view of multiples of modular precast foam duct bank 100 installed is shown. In this Figure, there are three units of straight pieces 170 installed to make up modular precast foam duct bank 100. The compressive strength of EPS will ensure that each of the straight pieces 170 will remain level within the resulting trench once the trench is backfilled. Additionally, each straight pieces 170 was installed in succession with each other and has three different utility conduits 118 running through the interior.

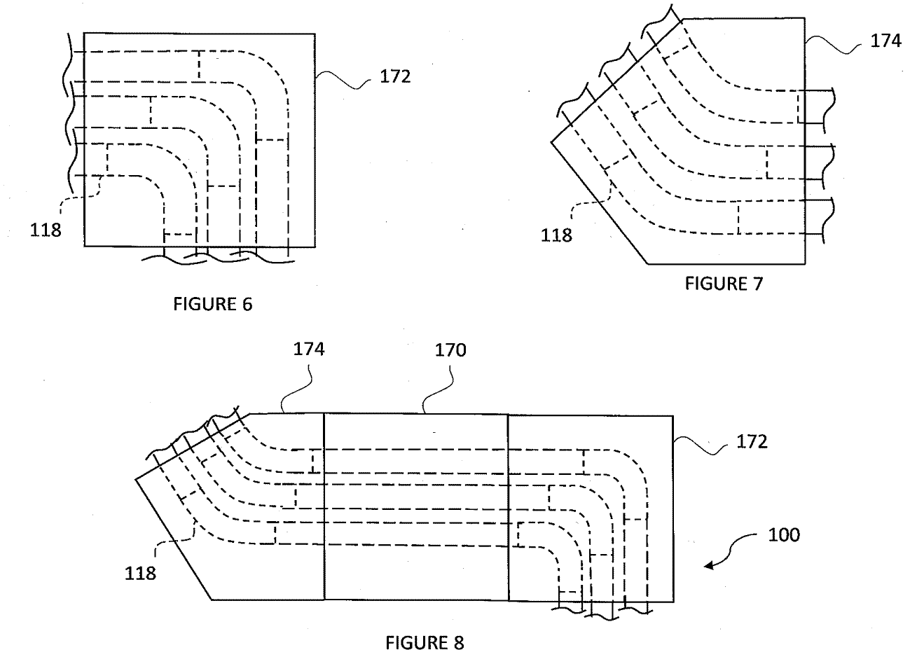

Referring now to FIG. 6, a top view of 90-degree piece 172 that can be a part of modular precast foam duct bank 100 is shown with utility conduits 118 running in the interior of the piece. 90-degree piece 172 shown here is one of the many different turns that modular precast foam duct bank 100 can take. This provides a tremendous amount of flexibility because not only does the 90-degree turn allow modular precast foam duct bank 100 to turn horizontally, but it can also allow modular precast foam duct bank 100 to turn vertically. As such, modular precast foam duct bank 100 can make horizontal turns along the planar surface of the trench, and it can also make vertical turns so that the systems elevation can change. Depending on the different turns required, conduit 118 can be directed upwards such as into an electrical room or turned along the planer surface of the trench to reach the utility connection point.

Referring now to FIG. 7, a top view of 60-degree piece 174 can be a part of modular precast foam duct bank 100 is shown with utility conduits 118 running in the interior of the piece. Much like the 90-degree piece 172, the 60-degree piece 174 allows modular precast foam duct bank 100 to turn either horizontally or vertically depending on the needs of the situation.

While both FIGS. 6 and 7 show 90-degree piece 172 and 60-degree piece 174 respectively, it is fully envisioned that modular precast foam duct bank 100 can also have blocks that include any other turn, such as a 30-degree or 45-degree turn. Additionally, if the needs of the job are completely unique, then a fully custom system can be designed and cut out of EPS foam. Additionally, it is to be appreciated that modular precast foam duct bank 100 may include conduit pathways which are not linear or limited to the various angles shown herein. In a preferred embodiment, modular precast foam duct bank 100 may be formed to include a combination of internal sweeps, straight runs, or angles in order to accommodate any type of conduit pathway that is needed in an application of the present invention.

Referring now to FIG. 8, modular precast foam duct banks 100 is shown with a singular straight piece 170, 90-degree piece 172, and 60-degree piece 174 installed. The ease of manufacture for EPS will generally allow for multiple different pieces that can be a part of modular precast foam duct bank 100 to be produced. A purchaser of the system will simply need to provide the length of each straight run and the type and quantity of turns that will occur so that the correct number of pieces can be easily ordered and installed on site. This view also highlights the different corresponding turns, such as sweep 174 and elbow 172, that utility conduit 118 will be able to make as well.

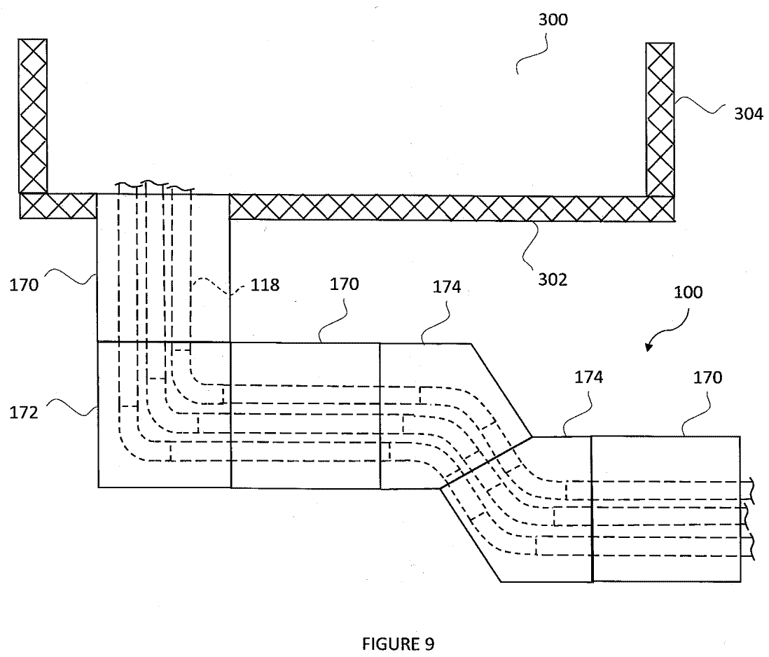

Referring now to FIG. 9, a side view of modular precast foam duct bank 100 fully assembled and running into space 300 is shown. This system for modular precast foam duct bank 100 has multiple different straight pieces 170, 90-degree pieces 172, and 60-degree pieces 174 installed to demonstrate the flexibility of modular precast foam duct bank 100. The different pieces that make up modular precast foam duct bank 100 allow it to be installed into any number of different spaces that need utility connections.

In a nonlimiting example, space 300 is a large data center that needs a multitude of utility conduits 118 run directly into the building. Modular precast foam duct bank 100 can run directly up from the ground and into the space by penetrating floor 302. These different turns are achieved by rotating the respective 90-degree pieces 172 and 60-degree pieces 174 in the corresponding direction. For example, 90-degree turn 172 was oriented so that utility conduit 118 can vertically turn up towards space 300. Additionally, it will be important for a utility installer to understand not only the dimensions of the overall building, but to also understand where walls 304 will be located. This will ensure that utility conduits 118 are available at the precise location they are needed and not at risk of being run to the wrong location.

Modular precast foam duct bank 100 can be installed in a similar manner at any building that needs utility connections. Additionally, the type of utilities can vary greatly as well. The utilities commonly run through utility conduit 118 typically range from electrical, cable, and internet connections; however, modular precast foam duct bank 100 can easily be configured to accommodate other types of conduits, such as plumbing lines, should the different types of conduit require protection when installed inside a trench.

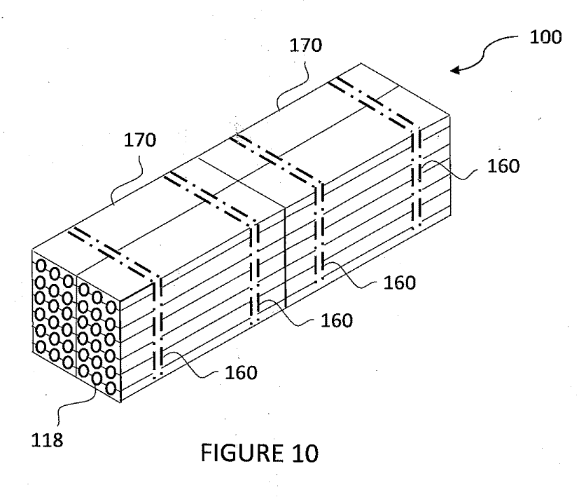

Referring now to FIG. 10, a perspective view of modular precast foam duct bank 100 is shown. This view shows multiple straight pieces 170 installed with straps 160 wrapped around each end of straight pieces 170 to make up modular precast foam duct bank 100. Straps 160 can be a wide variety of different straps such as lashing straps or tie-down straps, but any strap that is known in the art is fully envisioned and contemplated. Straps 160 provide additional stability to modular precast foam duct bank 100 when installed underground. This allows the system to better protect against sudden shifts of movement that the ground undergoes after installation, or if the system installed is in an area with high rates of seismic activity. The added layer of protection provides additional stability to preserve the structural integrity of the multitude of utility conduits 118 that are installed.

It is to be appreciated that the modular precast foam duct bank as disclosed herein can be manufactured to have varying conduit diameters and lengths. In addition to the end user having the ability to request duct banks 100 having a specific length, it is also possible for the user to modify the length of the duct banks 100 on site. Specifically, as may happen in construction projects of this nature, the specifically envisioned path of a duct bank may be challenged such as unforeseen buried obstacles uncovered during the excavation process, or perhaps a data center design change made after the duct banks have been manufactured. In any case, duct banks 100 may be separated into their separate pieces and cut to length to adjust for last minute plan changes. This is a relatively easy process using a cutting tool suitable for cutting expanded polystyrene (EPS).

As mentioned above, EPS is an ideal material to use for precast duct banks due to its high compressive strength rating, is lightweight, and has exceptional dimensional stability. for EPS foam. In addition, using a heated wire cutting tool, or a fine-toothed cutting saw, the EPS foam duct banks can be modified on site to accommodate any last-minute changes. Whether it involves cutting a small notch to avoid interference with a footing or pipe, or shortening a duct bank section to change the path of the duct bank, the ability for on-site modification makes the present invention ideal for any duct bank solution.

While the modular precast foam duct bank of the present invention as herein shown and disclosed in detail is fully capable of obtaining the objects and providing the advantages herein before stated, it is to be understood that it is merely illustrative of preferred and alternative embodiments of the invention and that no limitations are intended to the details of construction or design herein shown other than as described in the appended claims.

1. A precast foam duct bank comprising:
a top foam piece;
at least one intermediary foam piece; and
a bottom foam piece,
wherein the at least one intermediary foam piece is placed in between the top foam piece and the bottom foam piece.

2. The precast foam duct bank of claim 1, wherein the top foam piece further comprises a plurality of conduit recesses on the side of the top foam piece that contacts the at least one intermediary foam piece.

3. The precast foam duct bank of claim 2, wherein the bottom foam piece further comprises a plurality of conduit recesses on the side of the bottom foam piece that contacts the at least one intermediary foam piece.

4. The precast foam duct bank of claim 3, wherein the at least one intermediary foam piece further comprises a first plurality of conduit recesses that coincide with the plurality of conduit recesses on the top foam piece, and a second plurality of conduit recesses that coincide with the plurality of conduit recesses on the bottom foam piece.

5. The precast foam duct bank of claim 4, wherein the plurality of conduit recesses on the top foam piece, the first plurality of conduit recesses and the second plurality of conduit recesses on the at least one intermediary foam piece, and the plurality of conduit recesses on the bottom foam piece form a straight line.

6. The precast foam duct bank of claim 5, wherein the plurality of conduit recesses on the top foam piece, the first plurality of conduit recesses and the second plurality of conduit recesses on the at least one intermediary foam piece, and the plurality of conduit recesses on the bottom foam piece form a 90-degree turn.

7. The precast foam duct bank of claim 4, wherein the plurality of conduit recesses on the top foam piece, the first plurality of conduit recesses and the second plurality of conduit recesses on the at least one intermediary foam piece, and the plurality of conduit recesses on the bottom foam piece form a 45-degree turn.

8. A precast foam duct bank comprising:
a top foam piece having a side with a plurality of convex shapes separated by a plurality of flat portions;
a bottom foam piece having a side with a plurality of convex shapes separated by a plurality of flat portions; and
an intermediary foam piece having two sides opposed to each other, each side having a plurality of convex shapes separated by a plurality of flat portions,
wherein the locations of the flat portions on the top foam piece, the bottom foam piece, and the intermediary foam piece coincide with each other, thereby forming a plurality of contact points.

9. The precast foam duct bank of claim 8, further comprising an adhesive at the plurality of contact points to secure the top foam piece, the intermediary foam piece, and the bottom foam piece together.

10. The precast foam duct bank of claim 9, further comprising a first strap that wraps around a distal end of an exterior surface of the top foam piece, the intermediary foam piece, and the bottom foam piece.

11. The precast foam duct bank of claim 10, further comprising a second strap that wraps around a proximal end of the exterior surface of the top foam piece, the intermediary foam piece, and the bottom foam piece.

12. The precast foam duct bank of claim 11, wherein the plurality of convex shapes on the top foam piece, the intermediary foam piece, and the bottom foam piece forms a straight line.

13. The precast foam duct bank of claim 11, wherein the plurality of convex shapes on the top foam piece, the intermediary foam piece, and the bottom foam piece forms a 90-degree turn.

14. The precast foam duct bank of claim 11, wherein the plurality of convex shapes on the top foam piece, the intermediary foam piece, and the bottom foam piece forms a 45-degree turn.
